(19) United States
(12) Patent Application Publication
(10) Pub. No.: US 2005/0081254 A1
(43) Pub. Date: Apr. 14, 2005

(54) Method and system for configuring parameters of a configuration device using tag-length-value data structures

(76) Inventors: Peter Carlson, Atlanta, GA (US); Charles W. Roberts, Lawrenceville, GA (US); William Murray, Chamblee, GA (US); Charles Hardt, Lawrenceville, GA (US)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 10/683,011

(22) Filed: Oct. 10, 2003

(51) Int. Cl. H04N 7/16; H04N 7/173; H04J 3/16; H04N 7/18; H04J 3/22

(52) U.S. Cl. 725/140; 725/80; 725/133; 725/141; 370/470

(57) ABSTRACT

A method for configuring a parameter of a configuration device includes receiving a data signal including a sequence of tag-length-value data packets in the configuration device and configuring the parameter according to the sequence of tag-length-value data packets, where the sequence of tag-length-value data packets is configured to define a data object associated with the parameter.

### FIELD

The present method and system relate to configuring parameters of a configuration device. More particularly, the present method and system provide specific data structures for configuring parameters of a configuration device.

### BACKGROUND

In a typical cable television system, subscribers are provided with a set-top box or terminal. The set-top terminal includes electronic equipment that is used to connect the subscriber's television, and potentially other electronic equipment, with a cable network. The set-top box is usually connected to the cable network through a co-axial wall outlet.

The set-top box is essentially a computer that is programmed to process the signals from the cable network so as to provide the subscriber with cable services. The set-top box is typically programmed to include parameters that control features of the cable services. For example, the set-top box may include a parameter that controls a menu list of favorite channels. An operator of the cable network can update the parameters of the set-top box by broadcasting messages over the cable network to the set-top box. Broadcasts of cable services and messages over the cable network are routinely performed.

To update a parameter of a set-top box, conventional cable network systems require that the system be upgraded with more commands for parameter updates, or the cable network operator has to reprogram the actual code of each set-top box to reflect specific settings. In the latter case, because each set-top box has specific settings, the cable network operator distributes a separate object code release for each set-top box, in which the object code release essentially replaces the previous object code. Therefore, traditional updates to a set-top box parameter require a specific object code and a separate software build for each set-top box. In a cable network system with numerous subscribers, the cable network operator may want to update a set-top box parameter without creating a specific object code or performing a software build for each set-top box.

### SUMMARY

A method for configuring a parameter of a configuration device includes receiving a data signal including a sequence of tag-length-value data packets in the configuration device and configuring the parameter according to the sequence of tag-length-value data packets, where the sequence of tag-length-value data packets is configured to define a data object associated with the parameter.

### BRIEF DESCRIPTION OF THE DRAWINGS

The accompanying drawings illustrate various embodiments of the present method and system and are a part of the specification. Together with the following description, the drawings demonstrate and explain the principles of the present method and system. The illustrated embodiments are merely examples of the present invention and do not limit the scope of the invention.

FIG. 1 illustrates an exemplary embodiment of a system configured to implement parameter settings in a configuration unit.

FIG. 2 illustrates an exemplary sequence of data packets communicated over a transmission medium.

FIG. 3 illustrates an exemplary embodiment of a data structure configured according to a sequence of tag-length-value data packets.

FIG. 4 is a module-level diagram illustrating an exemplary embodiment of the flow of parameter configuration data.

FIG. 5 is a flow diagram illustrating an exemplary process for configuring a parameter of a configuration device.

FIG. 6 is a flow diagram illustrating an exemplary process for configuring parameters according to an exemplary sequence of data packets.

### DETAILED DESCRIPTION

The present specification describes a method and system for configuring settings of a configuration unit using a sequence of specific data packets. Specifically, the present method and system include using sequences of tag-length-value (“TLV”) data packets to configure specific parameters of a configuration device that is coupled to a television service network.

In the present specification and in the appended claims, a data packet is meant to be understood broadly as any discrete segment of data. Data signals are typically “packetized,” meaning that the data of a message or of software or firmware is divided into discrete “packets” or segments of data. Each packet includes a header that identifies the message or object of which that packet is a part and identifies the position of that packet's data within that message or object. Consequently, a receiver of the message can collect the packets of the message or object and reassemble the packetized data into the message or object that was transmitted. One type of data packet is a TLV data packet, in which the header of the packet is referred to as a tag or a type. The TLV data packet will be discussed in more detail below.

A “configuration device” is meant to be understood broadly as any electrical component such as a set-top box or a receiver unit that is configured to receive a signal from a head-end unit and process data associated with the received signal. The configuration unit may subsequently transmit a signal to one or more display devices. A “set-top box” is meant to be understood broadly as any device, circuitry, or sub-assembly that enables a display device such as a television to receive and display programming or network services.

In the following description, for purposes of explanation, numerous specific details are set forth in order to provide a thorough understanding of the present method and system for configuring parameters of a configuration device. It will be apparent, however, to one skilled in the art that the present method may be practiced without these specific details. Reference in the specification to “one embodiment,” “an embodiment,” or “an exemplary embodiment” means that a particular feature, structure, or characteristic described in connection with the embodiment is included in at least one embodiment. The phrases “in one embodiment” and “in an exemplary embodiment” appear in various places in the specification and are not necessarily all referring to the same embodiment.

Exemplary Overall Structure

Referring now to the drawings, FIG. 1 shows an exemplary setup (100) that includes a head-end unit (110) communicatively coupled to a configuration device (120) by a transmission medium (115). Signals, including TLV packets (118), can be transmitted from the head-end unit (110) to the configuration device (120) via the transmission medium (115). As shown in FIG. 1, the configuration device (120) is communicatively coupled to a display device (130) by a transmission medium (125). The elements of the exemplary setup (100) shown in FIG. 1 will now be discussed in further detail below.

As shown in FIG. 1, signals are transmitted from the head-end unit (110) to the configuration device (120). The head-end unit (110) can be any signal broadcaster capable of communicating with the configuration device (120) via the transmission medium (115), including but not limited to, a facility or component at a signal production office that communicates television, modem, or other services (collectively “services”) to subscribers. The services may include, but are in no way limited to, satellite, cable, analog, digital, or other type of television or cable services. A network operator may broadcast signals and messages from the head-end unit (110) to subscribers' configuration devices (120).

The head-end unit (110) typically includes a satellite dish antenna for receiving incoming programming and message signals from a broadcasting station that broadcasts services. The service signals may be transmitted to the head-end unit (110) in a number of ways including, but not limited to, a satellite dish, a fiber-optic cable, a coaxial cable, a phone line, a wireless medium, and the like. The head-end device (110) then transmits signals to the configuration device (120) via the transmission medium (115). The transmission medium (115) is any medium capable of carrying communications from the head-end unit (110) to the configuration device (120), including but not limited to a coaxial cable, a fiber-optic cable, a phone line, a medium for propagating wireless communications, etc.

The TLV packet (118) is a specific data packet structure that can carry data over the transmission medium (115). Components of a TLV packet (118) include a tag field, a length field, and a value field. The tag field identifies to which object or type of object the TLV packet (118) is associated. The length field defines the length of the value field by a number of bytes. A TLV packet (118) with no value field would have a length field of zero. The value field can carry any data that has been encoded in binary, digital, or other similar format.

A TLV packet (118) can be different sizes, which sizes are typically measured in bytes. A byte is a unit of storage for data in binary format. A TLV packet (1 18) can allocate one byte for the tag field and one byte for the length field. An extended TLV packet (118) may allocate two bytes for the tag field and two bytes for the length field. The number of bytes allocated to the value field is variable and indicated by the value of the length field.

A TLV packet (118) encodes data in a binary format for transmission from a source to a receiver. The receiver decodes and processes the TLV packet (118) according to its tag field, its length field, and its value field. TLV packets (118) can be transmitted in specific sequences.

The configuration device (120) receives and processes the service signals, including the TLV packets (118). The configuration device (120) can be any circuitry or programmable device configured to receive broadcast signals and process data associated with the received signals. The configuration device (120) may be associated with television or network services, including cable or satellite television services. In one exemplary embodiment, the configuration device (120) is a set-top box (STB) associated with cable television services.

The configuration unit (120) may be configured or programmed to control features and services that are made available to the display device (130). The configuration unit (120) can comprise processors, memory, peripherals, computer-readable mediums, input devices, output devices, transmitters, receivers, processor-readable mediums, or any other computer-related component. The configuration unit (120) may contain modules that process the service signals to establish and configure parameters that determine what features are made available to a display device (130). The parameters can include any setting related to the availability or functionality of the services broadcast by the head-end unit (110). Similarly, the parameters can include any setting related to the functionality of the display device (130) or the configuration unit (120). Parameters can include but are in no way limited to an address, a preference, a hardware setting, a regional setting, a system setting, a logo object, a color scheme, a language set, a font, a font selector, a font size, a menu option, a password setting, an audio language default, a menu language default, a subtitle setting, a subtitle language default, a teletext language default, a frequency table, a volume mute control, a parental control setting, a VCR tuning setting, a last channel control, a favorite channel control, a purchase cancellation control, a subscriber specified language setting, a preferred language setting, an aspect ratio mode setting, a display preference, a country code, a currency region, a rating region, a phone setting, an output channel setting, a time zone, a purchase setting, a download setting, a frequency setting, a customer preference, and the like. Parameters may be added to or removed from an existing set of parameters. The parental control setting can include but is not limited to a channel control, a rating control, a time control, and a cost control. Parameters may be separated into classes. In an exemplary embodiment, the parameters are categorized according to levels of security.

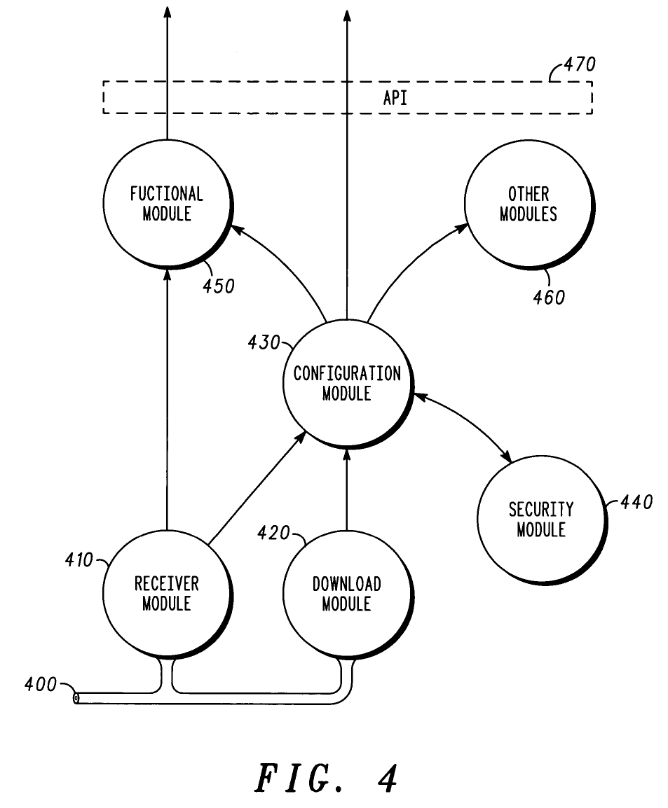

The parameters are represented in the circuitry of the configuration unit (120) as a data structure. The data structure can be defined by a sequence of TLV packets (118). In an exemplary embodiment, parameters are stored in a hierarchical tree structure that is defined by sequences of TLV packets (118) received by the configuration device (120). Sequences of TLV packets (118) can be used to access or configure the parameters that are associated with the tree data structure. An exemplary embodiment of the tree structure will be discussed below in relation to FIG. 3.

As shown in FIG. 1, the configuration device (120) is communicatively coupled to a display device (130), such as a television. The configuration unit (120) enables the display device (130) to receive and display television, network, or other services. The display device (130) can be any device capable of displaying television or network services. In an exemplary embodiment, the display device (130) is a television.

Although FIG. 1 shows one head-end unit (110), one TLV packet (118), one configuration device (120), and one display device (130) for illustrative purposes, it will be clear to one of ordinary skill in the art that the present system and method contemplates that the setup (100) can include more than one of each item, including a wide variety of different combinations of devices. In an exemplary embodiment, the head-end unit (110) interfaces with multiple configuration devices (120).

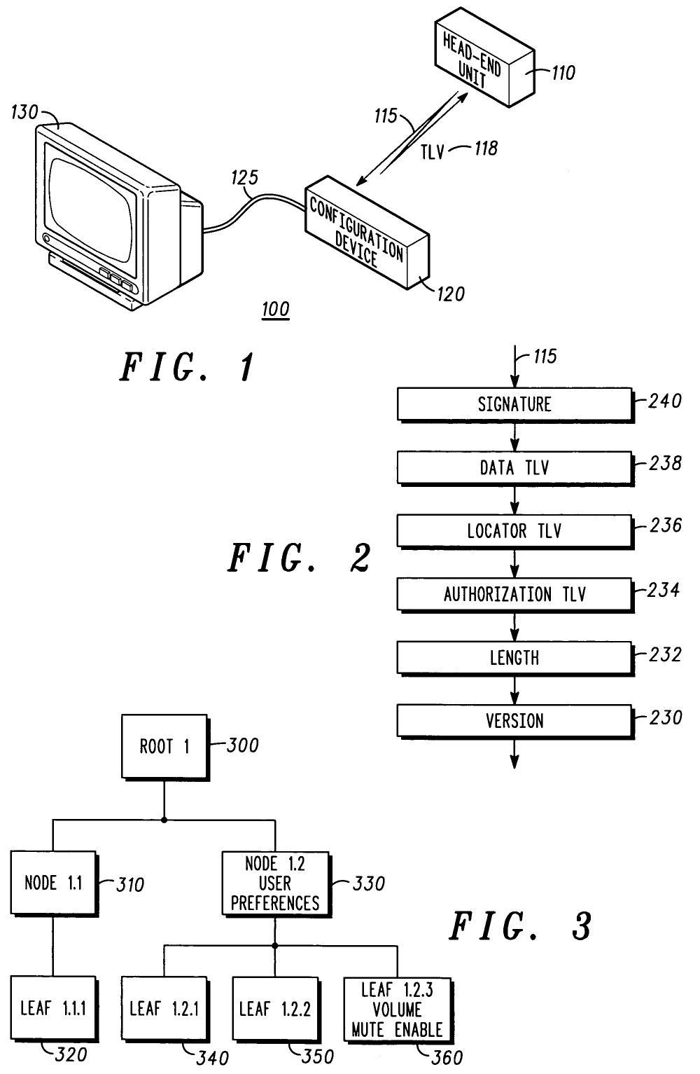

FIG. 2 illustrates an exemplary sequence of data packets being transmitted over the transmission medium (115). The sequence of data packets includes an exemplary sequence of TLV packets (118; FIG. 1) that can be used to define or configure a portion of the data structure that represents the parameters of the configuration device (120; FIG. 1). In the exemplary sequence, the version packet (230) carries a version number that indicates a configuration or update version. The version number can be used to indicate whether a sequence of data packets has previously been received and processed, thereby allowing the configuration unit (120; FIG. 1) to avoid duplicative processing of a stream of data packets. The version packet (230) is not necessary in some exemplary embodiments.

In the exemplary sequence, the length packet (232) follows the version packet (230). The length packet (232) carries a value indicating the number of bytes in the following sequence of TLV packets (118; FIG. 1). If no TLV packets (118; FIG. 1) follow the length packet (232), the length value will be zero.

In the exemplary sequence shown in FIG. 2, the authorization TLV packet (234) follows the length packet (232) and carries the tag-length-value setting for any authorization information. If no authorization is required for the configuration associated with the sequence of TLV packets (118; FIG. 1), the length value of the authorization TLV packet (234) will be zero. In some exemplary embodiments, the authorization TLV packet (234) is not necessary to the sequence of TLV packets (FIG. 1, (118)).

In the exemplary sequence shown in FIG. 2, the locator TLV packet (236) follows the authorization TLV packet (234). The locator TLV packet (236) carries the tag-length-value data associated with a location in the parameter-representative data structure of the parameter(s) that are to be updated by the data of the data TLV packet (238). In an exemplary embodiment, the data structure is a tree structure and the locator TLV packet (236) carries data that identifies a node that is associated with the parameter(s) to be configured.

There may be any number of data TLV packets (238) in the sequence of TLV packets (118; FIG. 1). The data TLV packet (238) carries the configuration data. The data TLV packets (238) may be nested. For example, one top level data TLV packet (238) may contain nested data TLV packets (238). Nested data TLV packets (238) can be extensively nested to represent a hierarchical structure, such as a tree structure that will be discussed below in relation to FIG. 3.

In the exemplary sequence shown in FIG. 2, a signature packet (240) follows the data TLV packet (238). If there are more than one data TLV packets (238), the signature packet (240) follows the last data TLV packet (238). The signature packet (240) carries authentication information that can verify reception of an entire sequence of data and the identity of the sender of the sequence of data by signing all of the data in the sequence of data packets from the version packet (230) to just before the signature packet (246). In some exemplary embodiments, the signature packet (240) may not be necessary.

FIG. 3 shows an exemplary implementation of a tree structure used to store or represent the parameters or settings of a configuration unit (120; FIG. 1). The tree structure is a form of data structure used to store and access data. Each location in the tree structure is a node. The top level node is referred to as the parent or root node, and bottom level nodes are referred to as leaf nodes. Nodes that have both a parent node above and another node below are simply called nodes. Each node may have a parent node and one or more child nodes. As shown in the exemplary implementation of FIG. 3, root node 1 (300) is the root node. Node 1.1 (310) is a child node of the root node 1 (300). Leaf node 1.1.1 (320) is a child node of node 1.1 (310). Leaf Node 1.1.1 (320) is a leaf node because it does not have a child node. As will be readily understood to one of ordinary skill in the art, the numbers associated with the nodes (1, 1.1, and 1.1.1) indicate the hierarchical order of the tree structure. For example, if node 1.1 (310) had a second child node, that child node would be node 1.1.2.

As shown in FIG. 3, node 1.2 (330) is a second child node of the root node 1 (300). Leaf node 1.2.1 (340), leaf node 1.2.2 (350), and leaf node 1.2.3 (360) are children nodes of node 1.2 (330). A node and the nodes hierarchically under that node are referred to as a branch of the tree structure. Therefore, node 1.2 (330) and its three children nodes can be called a branch of the tree structure. The tree structure is highly useful for configuring specific parameters of the configuration unit (120; FIG. 1) without changing other parameters. Configuration data can direct a change be made to specific node based on its unique identifier or that a change be made to a specific branch of the tree structure. Parameters can be configured with or without changing the tree structure. The tree structure can me modified by adding or removing nodes. In an exemplary embodiment, a parameter is associated with a node, and the parameter can be configured by updating or defining the associated node.

Groups of parameters can be configured by updating or defining an associated branch of nodes. In an exemplary embodiment, a branch of nodes is associated with a category or class of parameters. As shown in FIG. 3, node 1.2 (330) is associated with user preference parameters. The nodes that are hierarchically under node 1.2 (330) represent parameters related to user preference settings. For example, FIG. 3 shows that a user preference parameter, volume mute enable, is associated with leaf 1.2.3 (360), which is a child node of node 1.2 (330). By grouping categories of parameters into branches of a tree structure, a category of parameters can be configured or updated without updating or configuring all of the parameters represented by the tree structure. The tree structure also enables changes to be made to the parameters according to model-specific settings of different models of configuration units. Thus, a separate code rebuild is not necessary for each model of configuration unit (120; FIG. 1) that is fed by the head-end unit (110; FIG. 1). In an exemplary embodiment, a TLV packet (118; FIG. 1) carries data indicating applicable configuration unit (120; FIG. 1) models to which to apply configuration data carried by associated TLV packets (118; FIG. 1). If a model is listed within the model data, then it will process the configuration data. Otherwise, the model may ignore the configuration data. The TLV packet (118; FIG. 1) can be inserted into a sequence of data packets, such as the exemplary sequence shown in FIG. 2, in order to customize configurations to specific models of configuration units (120; FIG. 1).

As mentioned above in relation to FIG. 2, the tree structure can be defined by nested data TLV packets (238; FIG. 2). In an exemplary embodiment, a top level data TLV packet (238; FIG. 2) corresponds to a node in the tree structure. The nested data TLV packets (238; FIG. 2) correspond to the nodes that are hierarchically below or dependent from that node. The organization and data of the nested data TLV packets (238; FIG. 2) define the hierarchy and data of at least a part of the tree structure. In an exemplary embodiment, the nested organization of data TLV packets (238; FIG. 2) is defined by a sequence of TLV packets (118; FIG. 1) that is received and processed by the configuration unit (120; FIG. 1). In another exemplary embodiment, the parameters can be transmitted in any order.

A node of the tree structure or the data TLV packet (238; FIG. 2) can be associated with another data object such as a file. By pointing to another data object, larger data entities that cannot fit into a TLV packet (118; FIG. 1) can be used by the configuration unit (120; FIG. 1). This allows the configuration unit (120; FIG. 1) to reference multiple configuration data objects such as files. For example, a node may point to a data object such as a logo image bitmap file. If a TLV packet (118; FIG. 1) references another data object, the configuration unit (120; FIG. 1) can locate the memory location of the referenced data object or accept a transmission of the referenced data object by searching of an object name that is carried by the TLV packet (118; FIG. 1).

Exemplary Implementation and Operation

FIG. 4 shows an exemplary flow of data as it is processed by modules to configure one or more parameters of the configuration unit (120; FIG. 1). Service signals are received over the transmission medium (115; FIG. 2), which is represented by a coaxial connector (400) in FIG. 4. A receiver module (410) and a download module (420) receive configuration objects or files associated with the service signals and complete the related transmission reception operations. The receiver module (410) and the download module (420) communicate the received configuration objects to the configuration module (430). The download module (420) is configured to receive and process TLV configuration objects. The TLV configuration objects usually relate to configuration of static parameters or settings. The receiver module (410) is configured to receive and process other configuration commands, including data associated with individual parameters. The other configuration commands usually relate to dynamic parameters or settings that are usually configured or updated more frequently than the static parameters. In an exemplary embodiment, the receiver module (410) and the download module (420) interface with the configuration module (430) through separate interfaces.

The configuration module (430) receives and processes the configuration data objects. The configuration module (430) uses the data objects to configure parameters or settings by defining or updating the tree structure discussed above in relation to FIG. 3. The tree structure is either wholly or partially updated according to the data nested in TLV packets (118; FIG. 1).

If a parameter to be defined or updated is associated with a level of security that requires authorization for any update, the configuration module (430) will communicate the parameter identity and associated configuration data to the security module (440). The security module (440) can invoke a security algorithm to verify whether the data update to the parameter is authorized according to specified security settings. The security module (440) communicates a message to the configuration module (430) that indicates whether the particular data configuration is authorized or denied. The configuration module (430) will execute the update if the security module (440) authorized the update. The security module (440) is not necessary to all exemplary embodiments.

Once the configuration module (430) has updated parameter settings according to the configuration data, it can make data representing the parameters available to the functional module (450) and to other modules (460). The functional module (450) and the other modules (460) may require access to parameter data in order to perform their functions in accordance with the features set by the parameter settings. The functional module (450) and the other modules (460) can access the parameter settings to update their data to reflect any parameter changes made by the configuration module (430). Interfaces between the modules of the configuration unit (120; FIG. 1) may be configured in a wide variety of ways to allow use of different access mechanisms for accessing updated or current parameter settings. In one embodiment, modules can subscribe to be notified of changes to specific parameters, and the configuration module (430) is configured to communicate a notification to the subscribing modules when a change is made to the specified parameter(s) or to a specified class of parameters. The modules can communicate parameter changes in a wide variety of ways including but not limited to transmitting string-based objects and structure-based objects such as “C” structures. A “C” structure is an object defined using a C-based programming language. Data objects and their communication between modules can be structured according to other computer programming languages that are known in the art.

The functional module (450) is generally responsible for processing the service signals related to programming services and communicating the processed signals through an application program interface (API) (470) for use by the programming provider's software routines. The configuration module (430) can be configured to interface with the programming provider's software routines through the API (470). In an exemplary embodiment, the configuration module (430) is a sub-module of the functional module (450).

The other modules (460) may include but are not limited to a hardware abstract, an operating system abstract, and any other module that may need to access the parameter settings. The other modules (460) can interface with the configuration module (430) through a wide variety and combination of interfaces. In an exemplary embodiment, the hardware abstract interface and the operating abstract interface are application program interfaces.

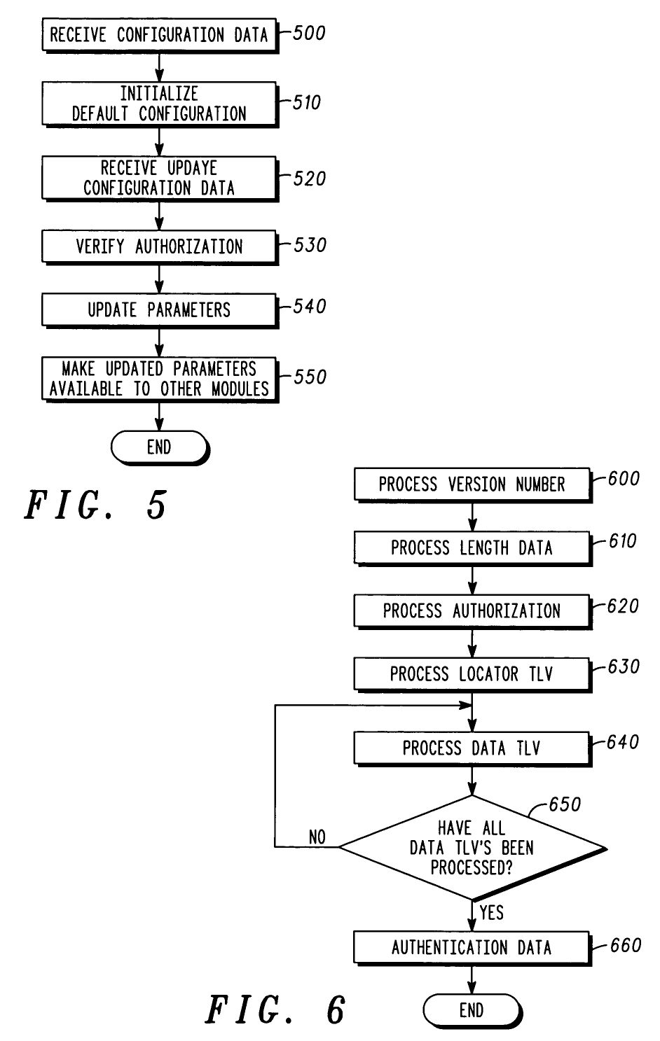

FIG. 5 shows an exemplary method for initializing and configuring the parameters of the configuration unit (120; FIG. 1). As illustrated in FIG. 5, the present method begins by the configuration unit (120; FIG. 1) receiving configuration data (step 500) from the head-end unit (110; FIG. 1). The configuration data can be received in any communicative fashion, including but not limited to a TLV protocol, a transmission control protocol (TCP), an internet protocol (IP), and a spooling process. The configuration data may also be received in a wide variety of formats such as a data object or file. In an exemplary embodiment, the configuration data is received (step 500) as part of a download of other data or software, such as a software download for initialization of a set-top box.

The configuration unit (120; FIG. 1) next initializes default configurations (step 510). This step can occur at any point between the manufacture and customer use of the configuration unit (120; FIG. 1). The received configuration data (step 500) can include default configuration data that is used to initialize parameter settings. In an exemplary embodiment, the configuration unit (120; FIG. 1) is initialized and the default configuration is set at installation of the configuration unit (120; FIG. 1). The default configuration becomes embedded until the next initialization.

The configuration unit (120; FIG. 1) next receives update configuration data (step 520). The update configuration data can be received in any way discussed above in relation to reception of configuration data (step 500). The configuration data may come in any readable format such as a data object, file, or the like. In an exemplary embodiment, the update configuration data is a data object that is communicated in TLV packets (118; FIG. 1).

In the exemplary process shown in FIG. 5, the configuration unit (120; FIG. 1) next verifies authorization (step 530) for a specific parameter configuration. Verification of authorization (step 530) is not necessary in all exemplary embodiments of the invention. Similarly, authorization (step 530) is omitted for any specific parameter configuration that does not require an authorization. The configuration can be authorized (step 530) in a wide variety of ways, including but not limited to comparing the specific parameter to be updated and the specific data for the update against a table of allowable updates for the specific parameter.

If an update is authorized (step 530), the configuration unit (120; FIG. 1) updates the parameter (step 540). The update to the parameter can be executed according to the discussion above in relation to FIG. 3. In an exemplary embodiment, a tree data structure representing parameter settings is configured in whole or in part to reflect any updates to the parameters. Once a parameter update has been implemented, the updated parameters are made available to other modules (step 550) and processes of the configuration unit (120; FIG. 1). This can be done in any way discussed above in relation to FIG. 4. Steps 520-550 can be repeated for any number of updates to the parameter settings.

FIG. 6 illustrates an exemplary processing of a sequence of data packets, including TLV packets (118; FIG. 1), used to configure one or more of the parameters of the configuration unit (120). The process shown in FIG. 6 relates to processing the exemplary sequence of data packets shown in FIG. 2. The version number is processed (step 600) to determine whether the sequence of data has been previously processed. The version number can be compared to version numbers associated with previously processed data. If the version number indicates that the data sequence has not already been processed, then processing of the data sequence is initiated. Otherwise, the data sequence can be ignored.

If the version number indicates an unprocessed data sequence, then the length data is processed (step 610). As discussed above in relation to FIG. 2, the length data indicates how many bytes of TLV data will follow the length data. The length data can be used to indicate when to stop processing a sequence of data because all of the packets have been processed.

Next, the authorization TLV data is processed (step 620) as discussed above in relation to FIG. 2. If the processing of the authorization TLV data (step 620) results in affirmative authorization, then the locator TLV data is processed (step 630). In an exemplary embodiment, processing of the locator TLV data (step 630) results in identification of a target node in a tree structure that represents parameter settings. The target node can be used as the beginning location for implementing updates in accordance with data carried by data TLV packets (238; FIG. 2).

The data carried by data TLV packets (238; FIG. 2) is processed (step 640) to implement parameter configurations beginning at the target node. After each data TLV has been processed (step 640), a check is performed to determine whether that data TLV was the final data TLV in the sequence (step 650). If it is determined that another data TLV remains to be processed, then it is processed (step 640). The processing of data TLV packets (238; FIG. 2) continues until all of the data TLV packets (238; FIG. 2) have been processed. Then the data is authenticated (step 660) as discussed in relation to FIG. 2.

In conclusion, the present method and system for configuring settings of a configuration unit using a sequence of specific data packets, in its various embodiments, allows for customized configurations of specific parameter settings without having to update all parameter settings with a code rebuild. Specifically, the present method and system provide for a sequence of tag-length-value (“TLV”) data packets that define a data structure that can be configured either in whole or in part to update specific parameter settings of a set-top box that is coupled to a television service network. The present method and system allows one code object to initiate parameter updates on a greater number of set-top boxes, thereby giving the network operator more control over features that are made available to set-top boxes per subscriber contracts, user preferences, regional specifications, geographic locations, government regulations, or telecommunications standards.

The preceding description has been presented only to illustrate and describe the present method and system. It is not intended to be exhaustive or to limit the present method and system to any precise form disclosed. Many modifications and variations are possible in light of the above teachings.

The foregoing embodiments were chosen and described in order to illustrate principles of the method and system as well as some practical applications. The preceding description enables others skilled in the art to utilize the method and system in various embodiments and with various modifications as are suited to the particular use contemplated. It is intended that the scope of the method and system be defined by the following claims.

1. A method for configuring a parameter of a configuration device comprising:
receiving a data signal in said configuration device, said data signal including a sequence of tag-length-value data packets; and
configuring said parameter according to said sequence of tag-length-value data packets, wherein said sequence of tag-length-value data packets is configured to define a data object associated with said parameter.

2. The method of claim 1, wherein said sequence of tag-length-value data packets includes nested tag-length-value data packets configured to define a hierarchical data object.

3. The method of claim 1, further comprising configuring a first parameter without configuring a second parameter.

4. The method of claim 1, further comprising configuring a first plurality of said parameters without configuring a second plurality of said parameters.

5. The method of claim 1, wherein said sequence of tag-length-value data packets comprises a locator tag-length-value packet and a data tag-length-value packet.

6. The method of claim 5, wherein said locator tag-length-value packet is configured to identify a node of said data object, said node indicating a location in said data object to be updated according to at least one of said data tag-length-value packets.

7. The method of claim 6, wherein said data tag-length-value packet carries configuration data for configuring said parameter associated with said node of said data object.

8. A system for configuring a parameter comprising:
a configuration device configured to receive a data signal, said data signal comprising a sequence of tag-length-value data packets; wherein said configuration device is further configured to define a data object associated with said parameter, wherein said data object is defined according to said sequence of tag-length-value data packets.

9. The system of claim 8, wherein said sequence of tag-length-value data packets includes a plurality of tag-length-value data packets nested to define a hierarchical data object.

10. The system of claim 8, wherein said configuration device is configured to configure a first parameter without configuring a second parameter.

11. The system of claim 8, wherein said sequence of tag-length-value data packets comprises a locator tag-length-value packet and a data tag-length-value packet.

12. The system of claim 11, wherein said locator tag-length-value packet is configured to identify a node of said data object, said node indicating a location in said data object to be updated according to said data tag-length-value packet.

13. The system of claim 12, wherein said data tag-length-value packet carries configuration data for configuring said parameter associated with said node of said data object.

14. The system of claim 8, wherein said configuration device comprises a set-top box associated with a network of television services.

15. The system of claim 8, further comprising:
a head-end device communicatively coupled to said configuration device, said head-end device configured to transmit said data signal to said configuration device; and
a display device communicatively coupled to said configuration device, said display device configured to display images associated with said data signal;
wherein said configuration device communicates said images to said display device according to a plurality of said parameters.

16. A system for configuring a parameter comprising:
a signal processing means for receiving and processing a data signal, said data signal including a sequence of tag-length-value data packets;
wherein said signal processing means in configured to configure said parameter according to said sequence of tag-length-value data packets, wherein said sequence of tag-length-value data packets is configured to define a data object associated with said parameter.

17. The system of claim 16, wherein said signal processing means comprises a set-top box.

18. The system of claim 17, wherein said set-top box is configured to receive a signal associated with a television service.

19. The system of claim 16, further comprising a display means communicatively coupled to said signal processing means.

20. The system of claim 19, wherein said display means comprises a television.

21. A configuration device for configuring a parameter comprising:
a download module configured to receive a data signal, said data signal comprising a sequence of tag-length-value data packets; and
a configuration module configured to define a data object associated with said parameter, wherein said data object is defined according to said sequence of tag-length-value data packets.

22. The configuration device of claim 21, wherein said sequence of tag-length-value data packets includes a plurality of tag-length-value data packets nested to define a hierarchical data object.

23. The configuration device of claim 21, wherein said configuration module is configured to configure a first parameter without configuring a second parameter.

24. The configuration device of claim 21, wherein said sequence of tag-length-value data packets comprises a locator tag-length-value packet and a data tag-length-value packet.

25. The configuration device of claim 24, wherein said locator tag-length-value packet is configured to identify a node of said data object, said node indicating a location in said data object to be updated according to said data tag-length-value packet.

26. The configuration device of claim 25, wherein said data tag-length-value packet carries configuration data for configuring said parameter associated with said node of said data object.

27. A processor-readable medium including processor instructions that instruct a processor to perform the steps of:
receiving a data signal, said data signal including a sequence of tag-length-value data packets; and
configuring said parameter according to said sequence of tag-length-value data packets, wherein said sequence of tag-length-value data packets is configured to define a data object associated with said parameter.

28. The processor-readable medium of claim 27, wherein said sequence of tag-length-value data packets includes nested tag-length-value data packets configured to define a hierarchical data object.

29. The processor-readable medium of claim 27, wherein said processor instructions further instruct a processor to configure a first parameter without configuring a second parameter.

30. The processor-readable medium of claim 27, wherein said sequence of tag-length-value data packets comprises a locator tag-length-value packet and a data tag-length-value packet, said locator tag-length-value packet being configured to identify a location in said data object to be updated according to said data tag-length-value packets.
